(19) United States
(12) Patent Application Publication
(10) Pub. No.: US 2024/0108920 A1
(43) Pub. Date: Apr. 4, 2024

(54) WEARABLE AIR PURIFICATION SYSTEM

(71) Applicant: Dyson Technology Limited, Wiltshire (GB)

(72) Inventors: Emma Victoria CARSON, Swindon (GB); Stephen Benjamin COURTNEY, Gloucester (GB)

(73) Assignee: Dyson Technology Limited, Wiltshire (GB)

(21) Appl. No.: 18/267,754

(22) PCT Filed: Oct. 7, 2021
(86) PCT No.: PCT/GB2021/052601

§ 371 Date: Jun. 15, 2023

(30) Foreign Application Priority Data
Dec. 17, 2020 (GB) 2020010.1

(51) Int. Cl. A62B 18/00; A62B 7/10

(52) U.S. Cl. CPC A62B 18/003; A62B 7/10; A62B 18/006

(57) ABSTRACT

A wearable air purification system including a wearable support configured to be supported on a head of a user; and an air delivery mask which is shaped to at least partially bound an air delivery region and to deliver a flow of air to the air delivery region. The wearable support includes a left side support and a right side support which support, at a front side of the system, the air delivery mask therebetween. The system further includes a motor housing for a motor which is configured to drive the air flow to or from the air delivery region, in use, wherein the motor mounting locates at a rear side of the user's head when the system is supported on the user's head in use.

### TECHNICAL FIELD

The invention relates to a wearable air purification system or wearable ‘purifier’.

### BACKGROUND

Air pollution is an increasing problem in modern society with an increasing variety of pollutants having known or suspected harmful effects on humans. In areas where levels of air pollution are particularly high, or in enclosed internal spaces, many individuals have taken to wearing face masks with the aim of filtering out at least a portion of the pollutants present in the air before it reaches the nose and mouth. However, face masks are not always a good solution because breathing is restricted when wearing a face mask and, when in conversation, it can be hard to make yourself heard, and to hear what others are saying, when masks are being worn.

More sophisticated solutions make use of a wearable air purifier which can be worn on the head and include motor and filter elements. For example, one approach involves a wearable support such as a neckband or headband to which a bar-like mask or visor is attached which stretches around in front of the mouth and delivers a jet of filtered air to the wearer. Such approaches show promise over conventional fabric masks, but they tend to be bulky which can limit their practicality as an object for daily wear.

In one known example, the wearable air purifier takes the general form of a pair of headphones, and indeed can be combined into a headphone assembly with audio functionality. The headphone assembly includes one speaker assembly which is worn over a first ear of the user and another speaker assembly which is worn over a second ear of the user. One or both of the speakers includes a filter for filtering pollutants from an airflow, an impeller for creating the airflow through the filter and a motor for driving the impeller. The speaker assemblies are carried on an arcuate headband which surrounds the upper portion of the user's head in a conventional manner. Whilst such assemblies provide a more sophisticated solution than a basic face mask, for some wearers they can be uncomfortable to use and the background noise from the motor is distracting.

It is against this background that the present invention has been devised.

### SUMMARY OF THE INVENTION

According to an aspect of the present invention there is provided a wearable air purification system comprising a wearable support configured to be supported on a head of a user; and an air delivery mask which is shaped to at least partially bound an air delivery region and to deliver a flow of air to the air delivery region. The wearable support includes a left side support and a right side support which support, at a front side of the system, the air delivery mask therebetween. The system further comprises a motor housing for a motor, the motor being configured to drive the air flow to the air delivery region, in use, wherein the motor housing locates at a rear side of the user's head when the system is supported on the user's head in use.

It is one benefit of the invention that the position of the motor at the rear side of the system removes the noise of operation of the motor from the vicinity of the wearer's ears. If the system is combined with an audio functionality, the noise of the motor does not, therefore, disturb the audio received through the speakers of the audio system. Even if no audio functionality is provided, the position of the motors at the rear side of the system ensures that there is limited or no disturbance to the user's hearing due to motor noise.

The wearable purification system may further comprise an audio speaker assembly for mounting over ears of the user. The audio speaker assembly is for delivering sound to the ears of the user. For example, the audio speaker assembly may include an audio speaker mounted in each of the left and right side supports. By way of further example, each of the left and right side supports may include an earpiece within which the respective left and right side speaker assembly is mounted.

In one embodiment, a rear section of each of the left and right side supports may be coupled to the associated audio speaker assembly via a movable coupling so as to permit adjustment of the rear section of each of the left and right side supports, and the motor housing, relative to the associated audio speaker. This enables the motor housing to be moved up and down, relative to the audio speakers, so that the motor housing can be moved out of the way of the rear side of the user's head if the user wants to rest their head on a resting surface.

In one embodiment, the left and right side supports may be integrally formed together with the motor housing.

Alternatively, in another embodiment, the left side support and the right side support may be connected together, at the rear side of the system, via the motor housing.

In a still further alternative embodiment, the left side support and the right side support may be integrally formed together as a unitary part. The motor housing may be carried by or otherwise mounted on the unitary part at the rear side of the system. In this arrangement the air flow path is defined, at least in part, within the unitary path. A communication pathway exists between the motor housing and the unitary part to ensure air generated by the motor reaches the air flow path.

It may be beneficial for the left side support and the right side support to be coupled to the air delivery mask via a movable coupling so as to permit adjustment of the left and right side supports, and the motor housing, relative to the air delivery mask. The movable coupling may be located in or on an earpiece of the side support.

The wearable support may further include a support device, such as an arcuate headband, which spans the top of the head in use. The headband may have first and second ends which connect with a respective one of the left and right side supports.

For example, the first and second ends of the headband may be connected to the left and right side supports by respective movable couplings. In this manner the headband is able to be moved, back and forth across the head of the user, to adjust the position of the headband when the device is worn, or to provide a means for stowing the headband when the device is not in use.

In examples, the headband may include an adjuster to adjust a span length of the headband over the top of the head.

The system may further includes a motor-driven impeller for generating the airflow under the operation of the motor, wherein each of the left and right side supports defines at least a part of an air flow path between the motor-driven impeller and the air delivery region.

The motor-driven impeller is typically mounted within the motor housing together with the motor.

The system may further comprise a filter associated with the motor for filtering air that is drawn into the air flow path.

The filter may be mounted within the motor housing together with the motor so that the airflow passes through the filter before the motor.

Conveniently, the air delivery mask may take the form of an elongate bar. The elongate bar may wrap around the sides of the user's face.

In some embodiments, the left and right side supports may be integrally formed with the air delivery mask.

By way of example, the air delivery mask may be slidably mounted relative to the left and right side supports so as to allow adjustment of a length of the system between the front side and the rear side. This provides a means for adjusting the system so that it is suitable for varying head shapes and sizes.

### BRIEF DESCRIPTION OF THE DRAWINGS

The present invention will now be described, by way of example only, with reference to the following Figures in which:

FIG. 1 is a side view of a user wearing a purification device in accordance with an embodiment of the invention; and

FIG. 2 is cross section, through a horizontal plane, of a purification device of an alternative embodiment.

### DETAILED DESCRIPTION

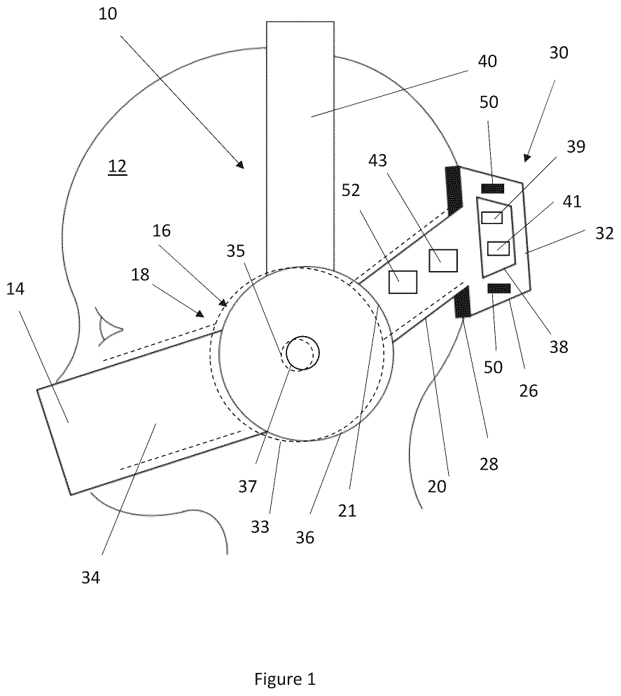

Referring to FIG. 1, a wearable air purification system, referred to generally as 10, includes a head worn device which the user supports on their head 12. The head worn device includes an air delivery mask 14 on a front side of the system which covers a user's mouth and bounds an air delivery region of the device. A wearable support, including left and right side supports, supports the air delivery mask 14 to the front. The left side support 16 is visible in the side view of FIG. 1, and this support is identical to the right side support which is obscured in FIG. 1 on the other side of the head. The right side support is thus identified by the feature identified by the dashed line referred to as 18. For brevity, only the side support 16 on the left hand side will be described in detail here.

The left hand side support 16 includes a rear section 20 which extends rearward of the ear of the user and terminates, at an end remote from the air delivery mask 14, at a motor mounting or motor housing 30. In the embodiment shown in FIG. 1, a front section of the side support 16 is integrally formed with the air delivery mask to the side of the user's head. The motor housing 30 includes a generally circular base region 28 which contacts the user's head and a tapered portion 26 which extends outwardly from the circular base region 28, away from the user's head 12, towards a flat top 32 of the motor housing 30.

The air delivery mask 14 takes the form of an elongate bar, of U-shaped construction, with a left side portion 34 of the mask extending around the left side of the user's face to connect with the left side support 16 at a left side earpiece 36 of the support 16. The left side earpiece 36 connects with a front end of the rear section 20 of the left side support 16. The U-shaped air delivery mask 14 is the same on the right hand side and includes a right side earpiece 33 which connects with a right side portion of the air delivery mask 14.

The air delivery mask 14 and the left and right side supports 16, 18 may be separate parts which are connected together to form a generally circular “loop” configuration which surrounds the user's head 12 when worn. In other embodiments, the left and right side supports 16, 18 may be integrally formed with the air delivery mask 14 so that the whole air flow path between the motor and the air delivery mask 14 is defined within a single and integrally formed channel through the device. It will be appreciated that the forward extent of the left and right side supports 16, 18 shown in FIG. 1 may vary from anywhere between the front edge of the earpiece 33, 36 to a point further down the side of the face, where the support meets the air delivery mask 14.

In further embodiments (not shown), the left and right side supports 16, 18 may be slidably mounted relative to the air delivery mask 14 so that the front-to-rear length of the device is variable. This provides the advantage that the device can be adjusted for different head sizes, depending on the user.

The left side earpiece 36 houses a speaker assembly 37 to provide the device with an audio functionality. The right side earpiece 33 houses a right side speaker assembly 35 in a similar manner. The speaker assemblies 35, 37 may take the form of a conventional speaker assembly, such as that used in a pair of audio headphones.

The air delivery mask 14 and the earpieces 33, 36 may be integrally formed, rather than being separate components as shown in FIG. 1. Likewise, the earpieces 33. 36 and the rear sections (e.g. 20) of the side supports 16, 18 may be integrally formed.

The motor housing 30 may be integrally formed with the rear sections of the side supports, or alternatively the motor housing may be a separate part which connects to the rear sections of the side supports centrally at a rear side of the device. In some embodiments, the motor housing 30, the air delivery mask 14, the side supports and the earpieces may all be formed as once piece. However, forming the earpieces 33, 36 as separate parts provides the advantage that they may be detachable to be removed from the device 10 if there is no need for audio functionality in the device.

It is possible to mount the rear section 20 of the left side support 16 to the earpiece 36 via a movable coupling 21 so that the rear section of the side support 16 can be pivoted forwards, relative to the earpiece and the air delivery mask 14. A similar arrangement (not identified) is provided on the right hand side of the device. This allows the position of the motor housing 30 to be moved, up and down, to adjust the resting position of the motor housing 30 at the rear of the head 12. For example, if the wearer of the device 10 wishes to lean back and rest their head against a resting surface behind them, it may be desirable to pivot the rear sections of the side supports upwards to raise the motor housing 30 higher up the head, out of the way of the resting surface.

An electric motor unit 38, which appears in cross section as a trapezoid, is mounted within the motor housing 30, the motor unit including a motor 39 and a motor-driven impeller 41 which are operable to drive an air flow through an air flow path defined within the left and right side supports and onwards to the air delivery mask 14. The air flow is directed equally through the left and right side supports 16, 18 by virtue of the central mounting of the motor housing 30 at the rear side of the device 10. The air flow paths on each side of the device come together in the air delivery region to deliver air to the wearer of the device. A battery 43 is also provided in the device 10 to deliver power to the motor unit 38. The battery is typically mounted within the motor housing 30 or in close proximity to the motor housing 30, as shown in FIG. 1.

The device 10 also houses a filter 50 through which air is drawn into the device 10 when the motor 38 is operated. The filter appears as two parts in FIG. 1, but this represents the section view through the motor unit. The filter serves to remove particulate matter from the air flow to prevent damage to the motor 38 and ensures the onward passage of clean, filtered air through the air flow path towards the air delivery region.

In some embodiments a post-motor filter 52 may also be incorporated into the motor housing 30 or elsewhere in the air flow path downstream of the motor 38. Thus, the provision of the pre-filter 50 protects the motor from damage due to dust and particulate matter drawn into the device with an airflow, and the post-motor filter 52 ensures any particulate matter which passes through the motor does not reach the air delivery region.

The wearable support further includes a support device in the form of a headband 40 (as shown in FIG. 1) which spans the user's head 12 between the left side support 16 and the right side support. The headband 40 is not an essential part of the device and may not be required for some wearers, although if provided it means the device can be more securely supported on the user's head. The headband 40 may be detachable from the device 10. If the headband 40 is removed, the position of the motor at the rear of the head 12 may need to be raised relative to the position shown in FIG. 1, so that the device 10 sits more securely on the user's head 12. The headband 40 may be mounted to the earpiece 36 via a movable coupling to allow the headband to move, back and forth, over the user's head.

A further feature of the invention is its adaptability for wear by different users. If provided, the headband 40 may include an adjuster which allows the span length of the headband 40 to be adjusted depending on the size of the head on which the device is worn. The adjuster may include an adjustable upper section which is slidable within side sections of the headband to reduce or lengthen the headband length, in the manner of a conventional set of headphones. This provides a convenient means of adjusting the size of the wearable support, depending on who is to wear the device.

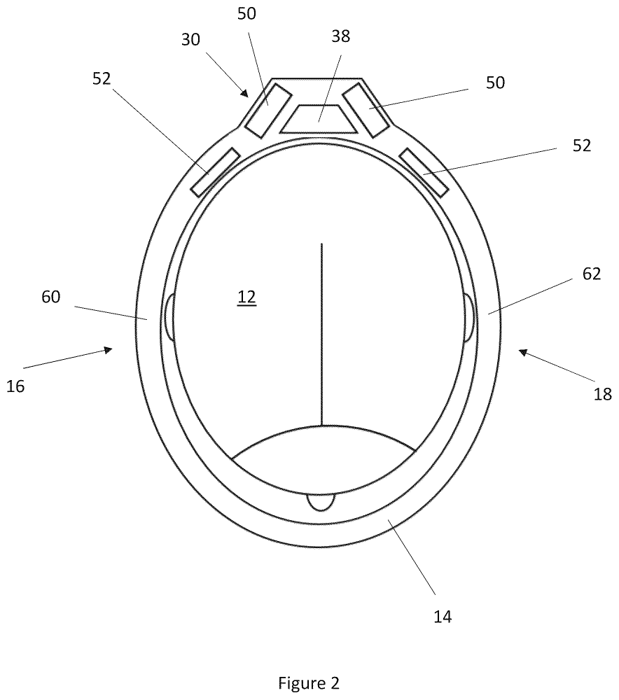

Referring to FIG. 2, in an alternative embodiment the earpieces of the device 10 are removed so the device does not have audio functionality. Instead, the left and right side supports, 16, 17 respectively, extend as elongate, curved channels from the motor housing 30 at the rear side of the device 10 to the air delivery mask 14 at the front side. Similar parts to those in FIG. 1 are denoted with like reference numerals and will not be described again in detail.

In FIG. 2, the filter 50 can be seen, arranged concentrically with the motor 38 within the motor housing 30. It will be appreciated that, as in FIG. 1, because of the cross section view shown in FIG. 2 the filter 50 appears as two parts, but is actually one part. Other forms of the filter are possible depending on the space requirements. The headband 40 has been removed from the illustration shown in FIG. 2, for the sake of clarity. The post filter 52 is located in each of the side supports 16, 17 to provide a second stage of filtration downstream of the motor 38. In the absence of the earpieces, the left and right side supports 16, 18 are continuous parts which extend from the rear side of the device at the motor housing 30 to the front side of the device at the air delivery mask 14. Each of the left and right side supports 16, 18 is typically provided with a bridge region, 60 and 62 respectively, which locate over and may rest on the left and right ears. Alternatively, the left and right side supports 16, 18 may grip the head of the wearer during use and or the purification system may be supported on the head of a wearer via the headband 40.

It is one benefit of the invention that the motor 38 for driving the airflow through the device to the air delivery region is mounted remote from the ears of the wearer, at the rear side of the device 10, as opposed to being mounted over the ears as in a known ‘headphone style’ purifier device. The motor 38 produces an audible noise in operation and so mounting it in a position displaced from the ears, and well removed from the opening into the ear canal, provides the benefit that there is limited or no impairment to the user's hearing due to the noise from motor operation. In addition, due to the shape of the human ear a position rearward of the ear helps to reduce the sound of the motor which can be heard during use. The rear side of the device 10 is also a beneficial position for the motor 38 as it balances with the air delivery mask 14 at the front side of the device to provide weight comfort for the user.

It will be appreciated that various changes and modifications can be made to the present invention without departing from the scope of the present application.

1. A wearable air purification system comprising:
a wearable support configured to be supported on a head of a user; and
an air delivery mask which is shaped to at least partially bound an air delivery region and to deliver a flow of air to the air delivery region;
wherein the wearable support includes a left side support and a right side support which support, at a front side of the system, the air delivery mask therebetween;
the system further comprising a motor housing for a motor, the motor being configured to drive the air flow to the air delivery region, in use, wherein the motor housing locates at a rear side of the user's head when the system is supported on the user's head in use.

2. The wearable purification system as claimed in claim 1, further comprising an audio speaker assembly for mounting over ears of the user.

3. The wearable purification system as claimed in claim 2, wherein the audio speaker assembly includes an audio speaker mounted in each of the left and right side supports.

4. The wearable purification system as claimed in claim 3, wherein a rear section of each of the left and right side supports is coupled to the associated audio speaker assembly via a movable coupling so as to permit adjustment of each of the left and right side supports, and the motor housing, relative to the associated audio speaker assembly.

5. The wearable purification system as claimed in claim 1, wherein the left and right side supports are integrally formed together with the motor housing.

6. The wearable purification system as claimed in claim 1, wherein the left side support and the right side support are connected together, at the rear side of the system, via the motor housing.

7. The wearable purification system as claimed in claim 1, wherein the left side support and the right side support are integrally formed together as a unitary part and wherein the motor housing is carried by or mounted on the unitary part at the rear side of the system.

8. The wearable air purification system as claimed in claim 1, wherein the wearable support further includes a headband which spans the top of the head in use, the headband having first and second ends which connect with a respective one of the left and right side supports.

9. The wearable air purification system as claimed in claim 8, wherein the first and second ends of the wearable support are connected to the left and right side supports by respective movable couplings.

10. The wearable air purification system as claimed in claim 8, wherein the headband includes an adjuster to adjust a span length of the headband over the top of the head.

11. The wearable air purification system as claimed in claim 1, including a motor-driven impeller for generating the airflow under the operation of the motor, wherein each of the left and right side supports defines at least a part of an air flow path between the motor-driven impeller and the air delivery region.

12. The wearable air purification system as claimed in claim 11, wherein the motor-driven impeller is mounted within the motor housing together with the motor.

13. The wearable air purification system as claimed in claim 1, including a filter associated with the motor for filtering air that is drawn into the air flow path.

14. The wearable air purification system as claimed in claim 13, wherein the filter is mounted within the motor housing together with the motor so that the air flow passes through the filter before the motor.

15. The wearable air purification system as claimed in claim 1, wherein the air delivery mask takes the form of an elongate bar.

16. The wearable air purification system as claimed in claim 1, wherein the left and right side supports are integrally formed with the air delivery mask.

17. The wearable air purification system as claimed in claim 1, wherein the air delivery mask is slidably mounted relative to the left and right side supports so as to allow adjustment of a length of the system between the front side and the rear side.
